(19) United States
(12) Patent Application Publication
(10) Pub. No.: US 2017/0316202 A1
(43) Pub. Date: Nov. 2, 2017

(54) RASP FOR SCRIPTING LANGUAGES

(71) Applicant: CHECKMARX LTD., Ramat Gan (IL)

(72) Inventor: Alexander Roichman, Petach-Tikva (IL)

(21) Appl. No.: 15/509,493

(22) PCT Filed: Jan. 11, 2016
(86) PCT No.: PCT/IB2016/050106

§ 371 Date: Mar. 8, 2017

Related U.S. Application Data
(60) Provisional application No. 62/104,760, filed on Jan. 18, 2015.

(51) Int. Cl. G06F 21/54; G06F 9/44; G06F 21/57

(52) U.S. Cl. CPC G06F 21/54; G06F 21/577; G06F 8/68; G06F 2221/033

(57) ABSTRACT

A method for runtime analysis of a software program (24) written in a scripting language. The method includes, before running the software program, adding patching code in the scripting language to the software program so as to define a proxy method that is to run in place of an existing method in the software program and comprises logic configured to provide information that is associated with operation of the existing method at runtime. Upon running the software program with the added patching code on a computer 32, the information provided by the logic in the proxy method is received and acted upon.

### CROSS-REFERENCE TO RELATED APPLICATION

This application claims the benefit of U.S. Provisional Patent Application 62/104,760, filed Jan. 18, 2015, which is incorporated herein by reference.

### FIELD OF THE INVENTION

The present invention relates generally to detecting and protecting against security vulnerabilities in computer programs, and specifically to runtime application self-protection (RASP).

### BACKGROUND

RASP techniques are used to protect software applications against security vulnerabilities by adding protection features into the application. In typical RASP implementations, these protection features are instrumented into the application runtime environment, for example by making appropriate changes and additions to the executable application code and/or operating platform. The instrumentation is designed to detect suspicious behavior during execution of the application and to initiate protective action when such behavior is detected. RASP is thus different from static application security testing (SAST), such as source code analysis, which is typically performed in order to detect security vulnerabilities before the code is compiled and run.

### SUMMARY

Embodiments of the present invention that are described hereinbelow provide improved methods, systems and software for protecting software programs against security vulnerabilities.

There is therefore provided, in accordance with an embodiment of the invention, a method for runtime analysis of a software program written in a scripting language. The method includes, before running the software program, adding patching code in the scripting language to the software program so as to define a proxy method that is to run in place of an existing method in the software program and includes logic configured to provide information that is associated with operation of the existing method at runtime. Upon running the software program with the added patching code on a computer, the information provided by the logic in the proxy method is received and acted upon.

In the disclosed embodiment, the software program includes a script that is embedded in a document, and adding the patching code includes adding a patching script to the document. Typically, the added patching script causes the computer, upon running the scripting language program, to replace all instances of the existing method occurring in the document with the proxy method. In one embodiment, adding the patching script includes inserting the patching script at a beginning of the document without analyzing or modifying the embedded script.

In some embodiments, the information provided by the logic in the proxy method is indicative of a security vulnerability in the scripting language program. In one embodiment, the proxy method causes the computer, upon running the scripting language program, to detect inputs to the program by the existing method, and to identify malicious strings in the inputs. For example, the proxy method causes the computer to identify a malicious string that is indicative of a cross-site scripting attack. Additionally or alternatively, acting on the information includes disabling at least a part of the software program that gave rise to the security vulnerability.

In other embodiments, the information is indicative of a flow of the software program at runtime, and receiving and acting on the information includes performing a static analysis of the software program that incorporates the information provided by the logic in the proxy method. In one embodiment, the added patching script causes the computer, upon running the scripting language program, to generate a trace of the software program, and incorporating the information includes building a call flow graph of the software program using the trace. Typically, the proxy method includes a trace method, which causes the computer, upon running the scripting language program, to record a caller and a callee in each method call in the software program, wherein the trace includes a call trace including the recorded caller and callee.

There is also provided, in accordance with an embodiment of the invention, apparatus for software analysis, including a memory, which is configured to receive a software program written in a scripting language. A processor is configured to add to the software program, before running of the software program, patching code in the scripting language so as to define a proxy method that is to run in place of an existing method in the software program and includes logic configured to provide information that is associated with operation of the existing method at runtime when the software program with the added patching code is run on a computer.

There is additionally provided, in accordance with an embodiment of the invention, a computer software product, including a computer-readable medium in which program instructions are stored, which instructions, when read by a computer, cause the computer to receive a software program written in a scripting language, to add to the software program, before running of the software program, patching code in the scripting language so as to define a proxy method that is to run in place of an existing method in the software program and includes logic configured to provide information that is associated with operation of the existing method at runtime when the software program with the added patching code is run on the computer, and upon running the software program with the added patching code, to receive and act on the information provided by the logic in the proxy method.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a system for secure operation of a software application, in accordance with an embodiment of the invention;

FIG. 2 is a flow chart that schematically illustrates a method for protection of a page containing script code, in accordance with an embodiment of the invention; and

FIG. 3 is a flow chart that schematically illustrates a method for software code analysis, in accordance with an embodiment of the invention.

### DETAILED DESCRIPTION OF EMBODIMENTS

Unlike compiled languages, such as C# and Java, which are converted to executable form before runtime, scripting languages are interpreted by the computer at runtime. Scripts (i.e., programs written in a scripting language) are therefore are not amenable to conventional RASP approaches, which generally involve adding instrumentation to the executable code. Common scripting languages include, for example, JavaScript™ and PHP, which are executed using an interpreter in a Web environment, either by the client-side browser (as in the case of JavaScript) or by the Web server (as in the case of PHP). Scripts written in such languages are commonly embedded within Web pages and other documents, to be read, interpreted, and run by the client or server when the document is accessed.

Embodiments of the present invention that are described herein provide tools and techniques that extend the RASP model to scripting languages. Although these embodiments are described hereinbelow specifically with reference to JavaScript, the principles of the present invention may similarly be applied, mutatis mutandis, to other scripting languages, both in Web environments and in other contexts in which scripts are used. Unlike RASP techniques for compiled languages, which generally require that the executable code be analyzed to identify points of interest and insert instrumentation code at these points, the present techniques for RASP instrumentation of scripting languages can be implemented simply by adding a fixed module to the script code, as explained below.

In some embodiments, a “patcher” software tool carries out the desired instrumentation before runtime by inserting a patching script into a document, such as a Web page, containing the original script. At runtime, the patching script automatically replaces all instrumentation points with a proxy method. This proxy method uses reflection techniques that cause the functions of the original script to run while at the same time implementing instrumentation logic that performs additional functions at the instrumentation points. For example, the patching script can instrument inputs and/or outputs, as well as other points of possible vulnerability in the script, so as to detect suspicious data at these points and take preventive action, such as raising alerts or blocking execution, as appropriate. Such instrumentation can be useful in protecting both servers and client computers from malicious exploitation of security vulnerabilities in scripts embedded in documents provided by the server.

Additionally or alternatively, the proxy methods implemented by the patcher can be configured to provide analytical information regarding runtime behavior of the script that cannot readily be derived by static analysis. For example, the patching script can identify dependencies between methods in the script, which are then used in building the call graph of the script program. This information can be provided to a SAST tool, in order to enable the SAST tool to derive a more accurate and complete analysis of the script code, including flows that could not be found by static analysis alone.

Thus, by appropriate choice of patching scripts and instrumentation logic, embodiments of the present invention may be used to extract and act on various types of information regarding runtime behavior of a script of interest. In the case of SAST support, the patching script is added to the script of interest and runs in a development or evaluation environment. To detect and prevent malicious behaviors, on the other hand, the patcher may add patching scripts to documents on a server, such as a Web server. Alternatively or additionally, a patcher plug-in may be added to client-side Web browsers, in order to add patching scripts to pages as they are downloaded to the browser. All such implementations of the principles of script instrumentation that are described herein are considered to be within the scope of the present invention.

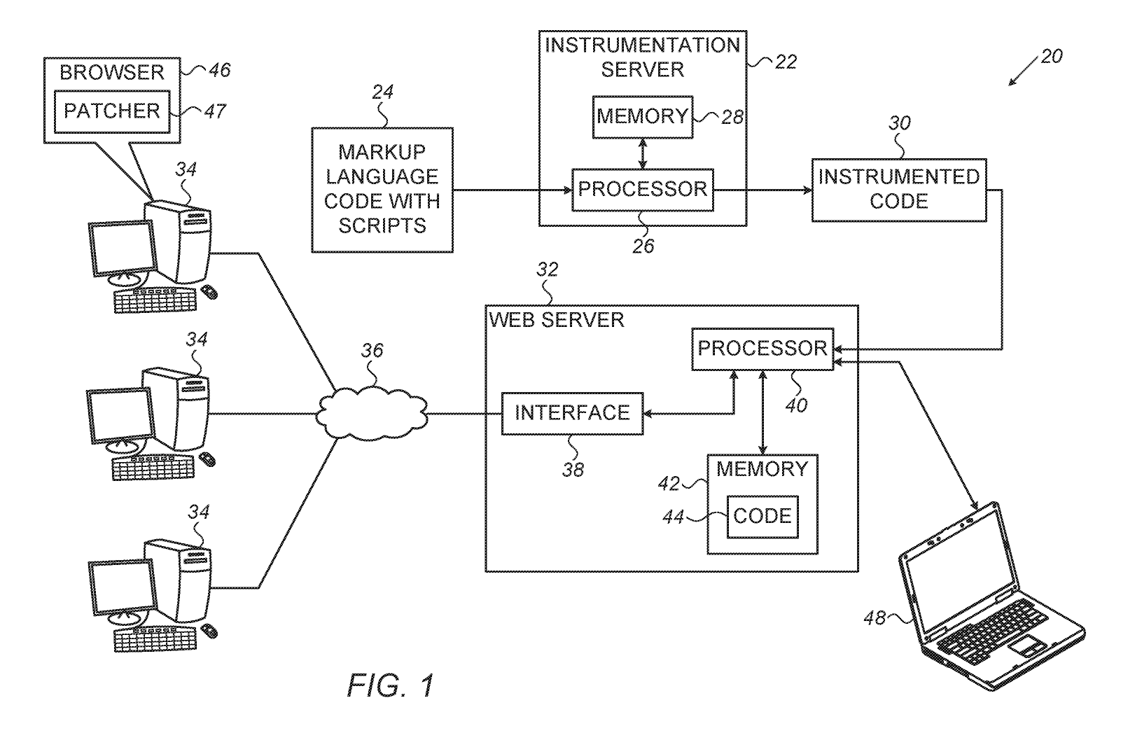

FIG. 1 is a block diagram that schematically illustrates a system 20 for secure operation of a software application, in accordance with an embodiment of the invention. System 20 is shown and described here, for the sake of concreteness and clarity, as an example of an operating environment in which the present techniques of code instrumentation and vulnerability detection can be implemented. In the present example, the application is a Web application, in which a Web server 32 provides Web pages, containing scripts, to client computers 34. Alternatively, these techniques may be implemented, mutatis mutandis, in substantially any computing environment with suitable computational resources and interfaces.

An instrumentation server 22 receives markup language code 24, such as HTML code, of Web pages that are to be protected against security vulnerabilities. At least some of these pages includes scripts in a suitable scripting language, such as JavaScript. Server 22 is typically a general-purpose computer, comprising a processor 26 and a memory 28, as well as other conventional computing resources, and is programmed in software to carry out the code analysis and instrumentation functions that are described herein. This software may be downloaded to server 22 in electronic form, over a network, for example. Additionally or alternatively, the code may be stored on tangible, non-transitory computer-readable media, such as optical, magnetic, or electronic memory media.

In the present embodiment, instrumentation server 22 receives markup language code 24 into memory 28 and applies RASP instrumentation to the code in the form of patching scripts, as described further hereinbelow. Instrumentation server 22 outputs the resulting instrumented code 30 to a Web server 32, which incorporates the code in Web pages that it delivers to client computers 34.

In the pictured scenario, Web server 32 communicates with client computers 34 over a network 36, such as the Internet, via a network interface 38. Client computers 34 request and receive content from server 32, such as Web pages, which are displayed by the client computers using a browser program 46, as is known in the art. As a further option, instead of or in addition to the patching function performed by server 22, a program running on client computers 34, such as a patcher plug-in 47 to browser program 46, inserts patching scripts into Web pages downloaded to the client computer.

Web server 32, like instrumentation server 22, is typically a general-purpose computer (and in some scenarios, some or all of the functions of server 22 may be implemented in server 32, rather than in a separate machine as shown in FIG. 1). Server 32 comprises a processor 40 and a memory 42, including a code memory area 44, which holds instrumented code 30 and possibly protective routines that can be invoked by the instrumentation in the code. The instrumentation in code 30 can detect, for example, malicious inputs submitted to server 32 from one or more of client computers 34 running scripts on Web pages provided by server 32, in an attempt to discover and exploit security vulnerabilities. The malicious inputs may originate directly from client computers 34, or they may originate from other servers (not shown) on network 36, with which client computers 34 communicate as a result of links on pages downloaded from server 32.

Based on analysis of the information provided by the code instrumentation, processor 40 invokes protective action upon detecting a possible attack. Additionally or alternatively, the protective action may be invoked and/or carried out by client computers 34. Typically, this protective action includes, at a minimum, writing alerts to a log file, which may then be viewed by a system operator via a suitable user interface on an operator terminal 48, which reads the log file. Alternatively or additionally, the instrumentation may cause the server and/or client computer to pass suspicious inputs and outputs to a separate program or server for analysis and alert generation. Further additionally or alternatively, protective actions taken by processor 40 may include interrupting service to a client computer 34 that has submitted a malicious input or possible shutting down the application entirely in extreme cases.

Like server 22, application server 32 is programmed in software to carry out the functions of detecting and protecting against vulnerabilities that are described herein. This software may be downloaded to server 32 in electronic form, over a network, for example. Additionally or alternatively, the code may be stored on tangible, non-transitory computer-readable media, such as optical, magnetic, or electronic memory media.

In addition to the RASP instrumentation functions that are described herein, server 22 may also be programmed to carry out other sorts of analysis of source code and/or executable code, such as SAST and/or DAST (dynamic application security testing). For example, in one embodiment, processor 26 applies RASP patching scripts in order to extract information regarding runtime behavior of script programs. The processor then uses this information in producing a more accurate and complete static analysis of the script code, as is described further hereinbelow.

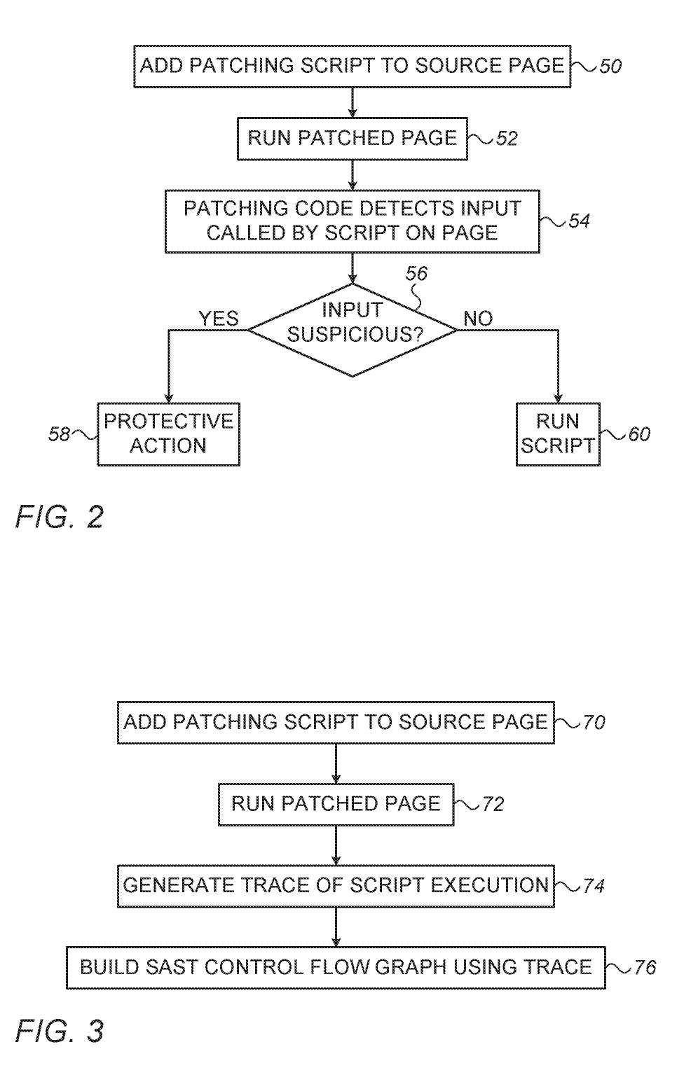

FIG. 2 is a flow chart that schematically illustrates a method for protection of a page containing script code, in accordance with an embodiment of the invention. As a preliminary step, instrumentation server 22 adds a patching script to a source page of markup language code 24, at an instrumentation step 50. Alternatively or additionally, such patching scripts may be added by Web server 32 or by client computers 34, as explained above.

As an example of the use of RASP in a script, we consider a script on a source page that is vulnerable to cross-site scripting (XSS) attacks. Such an attack may occur when a Web document has a uniform resource locator (URL) that contains a malicious string, and a document reads the URL string as an input and inserts it as an output into the document. For instance, the following source-page script could be used to echo the URL of a legitimate target document linked to the source page:

```
<html>
      <script>
        var href = document.location.href;
        document.write(“our URL is: ” + href);
      </script>
</html>
```

If a user, however, opens a target document at the following URL:
http://mysite.com/document.html?<script>XSS</script>,
   the above source-page script will cause the user's browser to read and execute the XSS script from the target document URL.

At step 50, a fixed patching script is added to the source-page document, without necessarily analyzing, modifying, or using any prior knowledge of existing scripts in the document that is to be instrumented. For example, the patcher can insert the following patching script at the beginning of each source page (for example, immediately following the page header) or other document that is to be protected, in order to detect and evaluate inputs to the original, embedded script that are read from other documents:

```
var oldWrite = document.write;
document.write = function(p)//this proxy method hides an original method
{
      //execute RASP logic here
      oldWrite.call(document, p); //this line calls the original write method
}
```

The “RASP logic” invoked in the above script checks the target document for malicious content, by matching the document content to a regular expression, for example, or otherwise parsing the content of the document.

Web server 32 downloads a patched page to a client computer 34, which displays the page and, in so doing, runs any scripts that are embedded in the page, at a page running step 52. The above patching code replaces (i.e., overrides) any existing call of the method “document.write” in the source mage with the above proxy method, which will execute RASP logic and then call the original “document.write” method. Adding the above patching script to any document will cause all “document.write” calls in such a document to be automatically instrumented (i.e., replaced by the proxy method). The patcher can thus instrument any document of interest without parsing the document and without any prior knowledge about what the document contains or what it is supposed to do.

The patching code running on client computer 34 and/or server 32 detects potential threats, for example by detecting and evaluating external inputs called by the script, at an input detection step 54. RASP logic invoked by the patching code decides whether the inputs are potentially malicious, at an input evaluation step 56. The RASP logic can, for instance, evaluate the data that are to be written from a given input, possibly by matching the data to a regular expression containing suspicious characters and character strings, in order to detect potentially malicious inputs, such as cross-site scripts in the above example.

When the RASP logic in the patching script determines at step 56 that a given input is suspicious, it causes client computer 34 and/or server 32 to take protective action. For example, browser 46 may be instructed to disable the script in question (or at least a part of the script, such as the script instruction that gave rise to the suspicious input) or to cease running all scripts on the current page or the current Web site. In case of a serious threat, the browser may shut down entirely. Additionally or alternatively, the RASP logic generates a log or other report, which can be evaluated subsequently via user terminal 48, and/or alerts an operator of server 32. On the other hand, when the input evaluated at step 56 appears innocent, browser 46 will proceed to run scripts and display the Web page content in the normal manner, at a script running step 60.

FIG. 3 is a flow chart that schematically illustrates a method for software code analysis, in accordance with another embodiment of the invention. As noted earlier, there are many application behaviors that can be detected at runtime but are hard to analyze with a purely static approach using existing SAST tools. Therefore, in the present embodiment, the SAST information is supplemented by adding RASP instrumentation to the script code, and running the code thus instrumented in order to extract additional information, such as function call flow information.

As an example, we consider the following script code:

1. var func=function(p)
2. {/*do something*/}
3.
4. var str=‘var’+String.fromCharCode(65)+‘=’;
5. str+=‘func;’;
6. eval(str);

### 7. A( );

This code first defines a method “func” and then builds a string, which will eventually contain “var A=func;”. The code then runs the “eval” method with this string as its argument. Finally, by running the method “A” in the last line, the script actually runs “func”. Existing SAST tools are incapable on their own of understanding that the call to “A” is actually a call to “func”.

In order to enable full analysis of script code such as the above, instrumentation server 22 adds a patching script to a source page of code 24, at an instrumentation step 70. For example, the following patching code can be used in instrumenting the above script:

```
for (name in this)
{
      fn = this[name];
      if (typeof fn === ‘function’)
      {
            var str = method + “ = trace(“ + method + ”,
            ‘“ + method + ”’);”;
            eval(str); //A = trace(A);
      }
}
```

This code finds all methods in a given script and replaces them with calls to a proxy method, which in this case comprises a trace method, such as the following:

```
function trace(func)
{
      /* write down a call to func */
      var result = func.apply(this, arguments);//call to the original method
}
```

Running this code each time the original script has a method call will cause a record to be made of the caller and callee, and this data can then be passed to a SAST tool running on server 22 or on another computer.

After adding a patching script such as the above to the original script code, server 22 runs the source page containing the instrumented script code, at a script running step 72. The instrumented code may be run in any suitable runtime environment, such as a browser running on server 22 or on a suitable client computer, or using the JavaScript .NET library available on line in the CodePlex.com Web site (hosted by Microsoft).

In the present example of RASP-assisted SAST, the instrumentation logic in the patching script extracts call flow information and generates a trace of script execution, at a trace generation step 74. The trace records, for each method call in the execution, which method has been called and where it was called from. Running the RASP logic each time the original script has a call causes a record to be made of the caller and callee. These data are passed to the SAST tool, which can then incorporate the method call into the static analysis results.

Specifically, referring back to the sample code above the instrumentation logic will indicate that “A( )” at line 7 actually calls the “func” method, and may thus generate a trace including the following XML listing after running the script:

```
<call>
      <caller line ‘7’>A</caller>
      <called line ‘1’>foo</called>
</call>
```

This XML listing is passed to the SAST tool, which can then incorporate the method call into the static analysis results.

The SAST tool can use the trace in building a complete control flow graph of the script program under evaluation, in a SAST step 76. For example, For example, PCT International Publication WO 2008/047351, whose disclosure is incorporated herein by reference, describes a static code analysis (SCA) engine that scans source code and extracts the data and control flows of the code (using code flow and data flow graphs). An SCA engine of this sort is available commercially from Checkmarx Ltd. (Tel Aviv, Israel). The trace provided at step 74 provides the SCA engine with call flow details that might otherwise be missed.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for runtime analysis of a software program written in a scripting language, the method comprising:
before running the software program, adding patching code in the scripting language to the software program so as to define a proxy method that is to run in place of an existing method in the software program and comprises logic configured to provide information that is associated with operation of the existing method at runtime; and
upon running the software program with the added patching code on a computer, receiving and acting on the information provided by the logic in the proxy method.

2. The method according to claim 1, wherein the software program comprises a script that is embedded in a document, and wherein adding the patching code comprises adding a patching script to the document.

3. The method according to claim 2, wherein the added patching script causes the computer, upon running the scripting language program, to replace all instances of the existing method occurring in the document with the proxy method.

4. The method according to claim 2, wherein adding the patching script comprises inserting the patching script at a beginning of the document without analyzing or modifying the embedded script.

5. The method according to claim 1, wherein the information provided by the logic in the proxy method is indicative of a security vulnerability in the scripting language program.

6. The method according to claim 5, wherein the proxy method causes the computer, upon running the scripting language program, to detect inputs to the program by the existing method, and to identify malicious strings in the inputs.

7. The method according to claim 6, wherein the proxy method causes the computer to identify a malicious string that is indicative of a cross-site scripting attack.

8. The method according to claim 5, wherein acting on the information comprises disabling at least a part of the software program that gave rise to the security vulnerability.

9. The method according to claim 1, wherein the information is indicative of a flow of the software program at runtime, and wherein receiving and acting on the information comprises performing a static analysis of the software program that incorporates the information provided by the logic in the proxy method.

10. The method according to claim 9, wherein the added patching script causes the computer, upon running the scripting language program, to generate a trace of the software program, and wherein incorporating the information comprises building a call flow graph of the software program using the trace.

11. The method according to claim 10, wherein the proxy method comprises a trace method, which causes the computer, upon running the scripting language program, to record a caller and a callee in each method call in the software program, wherein the trace comprises a call trace including the recorded caller and callee.

12. Apparatus for software analysis, comprising:
a memory, which is configured to receive a software program written in a scripting language; and
a processor, which is configured to add to the software program, before running of the software program, patching code in the scripting language so as to define a proxy method that is to run in place of an existing method in the software program and comprises logic configured to provide information that is associated with operation of the existing method at runtime when the software program with the added patching code is run on a computer.

13. The apparatus according to claim 12, wherein the software program comprises a script that is embedded in a document, and wherein the patching code comprises a patching script that is added to the document.

14. The apparatus according to claim 13, wherein the added patching script causes a computer, upon running the scripting language program, to replace all instances of the existing method occurring in the document with the proxy method.

15. The apparatus according to claim 13, wherein the processor is configured to add the patching script at a beginning of the document without analyzing or modifying the embedded script.

16. The method according to claim 12, wherein the information provided by the logic in the proxy method is indicative of a security vulnerability in the scripting language program.

17. The apparatus according to claim 16, wherein the proxy method causes a computer, upon running the scripting language program, to detect inputs to the program by the existing method, and to identify malicious strings in the inputs.

18. The apparatus according to claim 17, wherein the proxy method causes the computer to identify a malicious string that is indicative of a cross-site scripting attack.

19. The apparatus according to claim 16, wherein the proxy method causes a computer, upon running the scripting language program, to disable at least a part of the software program that gave rise to the security vulnerability.

20. The method according to claim 12, wherein the information is indicative of a flow of the software program at runtime, and wherein the processor is configured to perform a static analysis of the software program that incorporates the information provided by the logic in the proxy method.

21. The apparatus according to claim 20, wherein the added patching script causes a computer, upon running the scripting language program, to generate a trace of the software program, and wherein the processor is configured to build a call flow graph of the software program using the trace.

22. The apparatus according to claim 21, wherein the proxy method comprises a trace method, which causes the computer, upon running the scripting language program, to record a caller and a callee in each method call in the software program, wherein the trace comprises a call trace including the recorded caller and callee.

23. A computer software product, comprising a computer-readable medium in which program instructions are stored, which instructions, when read by a computer, cause the computer to receive a software program written in a scripting language, to add to the software program, before running of the software program, patching code in the scripting language so as to define a proxy method that is to run in place of an existing method in the software program and comprises logic configured to provide information that is associated with operation of the existing method at runtime when the software program with the added patching code is run, and upon running the software program with the added patching code, to receive and act on the information provided by the logic in the proxy method.

24. The product according to claim 23, wherein the software program comprises a script that is embedded in a document, and wherein the patching code comprises a patching script that is added to the document.

25. The product according to claim 24, wherein the added patching script causes the computer, upon running the scripting language program, to replace all instances of the existing method occurring in the document with the proxy method.

26. The product according to claim 24, wherein the instructions cause the computer to add the patching script at a beginning of the document without analyzing or modifying the embedded script.

27. The method according to claim 23, wherein the information provided by the logic in the proxy method is indicative of a security vulnerability in the scripting language program.

28. The product according to claim 27, wherein the proxy method causes the computer, upon running the scripting language program, to detect inputs to the program by the existing method, and to identify malicious strings in the inputs.

29. The product according to 28, wherein the proxy method causes the computer to identify a malicious string that is indicative of a cross-site scripting attack.

30. The product according to claim 27, wherein the proxy method causes the computer, upon running the scripting language program, to disable at least a part of the software program that gave rise to the security vulnerability.

31. The method according to claim 23, wherein the information is indicative of a flow of the software program at runtime, and wherein the instructions cause the computer to perform a static analysis of the software program that incorporates the information provided by the logic in the proxy method.

32. The product according to claim 31, wherein the added patching script causes the computer, upon running the scripting language program, to generate a trace of the software program, and wherein the instructions cause the computer to build a call flow graph of the software program using the trace.

33. The product according to claim 32, wherein the proxy method comprises a trace method, which causes the computer, upon running the scripting language program, to record a caller and a callee in each method call in the software program, wherein the trace comprises a call trace including the recorded caller and callee.
